(19) United States
(12) Patent Application Publication
(10) Pub. No.: US 2003/0056546 A1
(43) Pub. Date: Mar. 27, 2003

(54) Photonic crystal materials and devices

(76) Inventors: Richard O. Claus, Blacksburg, VA (US); Keith C. Huie, Blacksburg, VA (US)

Correspondence Address: McGuireWoods, Suite 1800, 1750 Tysons Boulevard, McLean, VA, 22102-4215, US

(21) Appl. No.: 10/245,718

(22) Filed: Sep. 18, 2002

Related U.S. Application Data
(60) Provisional application No. 60/322,730, filed on Sep. 18, 2001.

(51) Int. Cl. C03B 37/02

(52) U.S. Cl. 65/386; 65/435; 65/433

(57) ABSTRACT

The invention describes a procedure for manufacturing photonic crystals and passive and active optoelectronic device components comprising of photonic crystals. The manufacturing approach draws upon the mature technology of producing microchannel plates (MCPs). Based on this manufacturing approach, photonic crystal structures with or without defects can be fabricated. The photonic band gaps produced in the presented invention can be made passive or active. A photonic crystal structure is described that contain different photonic band gap regions. Additionally, photonic crystal structures filled with different refractive indexes are described. The photonic crystals of the present invention maybe used as filters, phase shifters, splitters, couplers, multiplexers, demultiplexers, modulators, variable optical attenuators, gain equalizers, etc. for optical communication applications.

### RELATED APPLICATIONS

This application is based on and claims priority to U.S. provisional application No. 60/322,730 filed Sep. 18, 2001, herein incorporated by reference in its entirety.

### FIELD OF THE INVENTION

The present invention is directed to the fabrication of photonic crystal materials and devices. More particularly, the present invention is directed to applying this fabrication technique to engineer photonic crystal devices having regions with different photonic band gap frequencies.

### BACKGROUND OF THE INVENTION

Photonic crystals are a class of periodic composite structures consisting of varying low and high refractive index materials that exhibit a forbidden band, or Photonic Band Gap (“PBG”) of frequencies whereby incident electromagnetic waves cannot propagate. The electromagnetic wave transmission properties of the photonic crystal are governed by the size and spacing of these periodic regions composing the crystal structure that are both on the order of the wavelength of the radiation to be controlled. Photonic crystals represent an area of materials that can be utilized in optical communications, including, for example, improved devices for wavelength division multiplexing (“WDM”) applications.

### SUMMARY OF THE INVENTION

The present invention is directed to passive and active photonic crystals fabricated using concepts similar to those used in microchannel plate (“MCP”) technology. Utilizing this approach, two and three dimensional photonic crystals can be made. The present invention is also directed to providing a range of devices for the control of the propagation, localization, and switching of electromagnetic radiation.

Accordingly, one embodiment of the present invention includes a photonic crystal comprising a body portion having at least two different PBG regions. The PBG regions may comprise a plurality of crystal structures, wherein the size of the crystal elements within the bulk structure is different for each different PBG region. In preferred embodiments, the photonic crystal comprises a plurality of PBG regions, having different refractive indices or geometric shape for each PBG region. The crystal structure of at least one of the PBG regions may include an active material that exhibits different refractive indices depending on the field applied to the photonic crystal. The active material exhibits different refractive indices based on the application of a field selected from the group consisting of electrical, magnetic, optical, thermal, and combinations thereof.

Still further, another embodiment of the present invention includes a waveguide extending through the one or more photonic band gap regions. The waveguide may be longitudinally offset by about a fraction of the wavelength of electromagnetic radiation to be propagated through the waveguide. In other embodiments, the waveguide may be divided into at least two separate paths extending through the photonic crystal. Further, the separate paths may extend through different photonic band gap regions.

The present invention includes a method for making a photonic crystal having at least one photonic band gap region comprising the steps of stacking a plurality of fiber canes together to form an array, wherein the plurality of fiber canes comprises a set of fiber canes having a set of core glass; reducing the diameter of the set of core glass; cleaving a portion of the array to form a plate; and removing at least a portion of the set of core glass to form a photonic crystal with at least one photonic band gap.

The present invention also includes a method for making a photonic crystal having one or more photonic band gap regions comprising the steps of stacking a plurality of fiber canes together to form an array, wherein the plurality of fiber canes comprises a first set of fiber canes having a first set of core glass and a second set of fiber canes having a second set of core glass, where the first set of core glass has a different diameter than the second set of core glass; reducing the diameter of the first set of core glass and the second set of core glass; cleaving a portion of the array to form a plate; and selectively removing at least a portion of the first set of core glass and the second set of core glass from the plate to form a photonic crystal.

The step of reducing the diameter of the first set of core glass and the second set of core glass may include the step of drawing the array two or more times. Further, the step of stacking a plurality of fiber canes may further include stacking a third set of fiber canes having a third set of core glass that is not removed which defines a waveguide in the photonic crystal.

Further, the present invention includes a method for making a photonic crystal having a waveguide comprising the steps of stacking a plurality of fiber canes together to form an array, wherein the plurality of fiber canes comprises a first set of fiber canes having a first set of core glass and a second set of fiber canes having a second set of core glass; reducing the diameter of the first set of core glass and the second set of core glass; cleaving a portion of the array to form a plate; and selectively removing at least a portion of the first set of core glass from the plate to form a photonic crystal having a waveguide defined by the location of the second set of fiber canes in the array.

The method may also include stacking the second set of fiber canes to provide a linear waveguide in the photonic crystal. Other embodiments include stacking the second set of fiber canes to define a waveguide longitudinally offset by about a fraction of the wavelength of the electromagnetic radiation to be propagated through the waveguide. Still further, the second set of fiber canes may be stacked to define a waveguide having two or more paths extending through the photonic crystal.

The invention also includes a method for making a photonic crystal having one or more photonic band gap regions comprising the steps of stacking a plurality of fiber canes together to form an array, wherein the plurality of fiber canes comprises a first set of fiber canes having a first set of core glass and a second set of fiber canes having a second set of core glass, wherein the first set of core glass has different chemical etching properties than the second set of core glass; reducing the diameter of the first set of core glass and the second set of core glass; cleaving a portion of the array to form a plate; and etching at least a portion of the first set of core glass to form a photonic crystal.

Still further, the present invention includes a method for making a photonic crystal having at least two photonic band gap regions comprising the steps of stacking a plurality of fiber canes together to form an array, wherein the plurality of fiber canes comprise a hollow clad glass with core glass having a diameter inserted therethrough;

reducing the diameter of the core glass; cleaving a portion of the array to form a plate; selectively removing at least a portion of the core glass such that the plate defines a plurality of holes corresponding to the removal of the core glass; and filling at least a portion of the holes with a material having a different refractive index than the remaining holes.

In some embodiments, the material exhibits a different refractive index when an energy field is applied. The energy field may include, but is not limited to magnetic, thermal, optical, and electrical energy fields.

### BRIEF DESCRIPTION OF THE FIGURES

FIG. 1 illustrates the MCP photonic crystal fabrication process.

FIG. 2 is an illustration of a boule cleaved and polished to manufacture photonic crystals.

FIG. 3A is an illustration of a MCP photonic crystal comprised of two different sized fiber cores and thus two photonic band gaps (“PBG”).

FIG. 3B is an illustration of a MCP photonic crystal comprised of fiber cores with different indices of refraction and thus two PBGs.

FIG. 3C is an illustration of a MCP photonic crystal where solid, opposed to hollow, clad rods are utilized to form waveguides in the photonic crystal structure.

FIG. 3D is an illustration of a MCP photonic crystal that incorporates defects produced by a change in the index of refraction and the fiber core geometry and the inclusion of solid clad rods and acts as a filter that separates overlapping wavelengths between PBG 1, PBG 2, and PBG 3.

FIG. 4A is an illustration of a MCP photonic crystal that induces fixed phase delays by using incremental quarter-wave additions to the optical channel length.

FIG. 4B is an illustration of a MCP photonic crystal power splitter or combiner.

FIG. 4C is an illustration of a MCP photonic crystal multiplexer/demultiplexer that combines or separates wavelengths within PBG 1, 2, and 3.

FIG. 5 is an illustration of an active MCP photonic crystal switch that is controlled via an applied field.

### DETAILED DESCRIPTION OF THE INVENTION

The present invention is directed to photonic crystals that allow for the passive or active control of the propagation, localization, and/or switching of electromagnetic radiation. The method for making these photonic crystals draws upon the mature technology of producing microchannel plates (“MCP”), which are conventionally used in infrared (IR) viewers, whereby multiple large core fiber “canes” with specific core and clad properties are stacked, drawn, and fused together to form periodic crystal structures.

Of particular interest is the application of photonic crystals in the optical telecommunication operational wavelength range, namely 1300 nm to 1550 nm, although the technology described could be extended to wavelengths in the ultraviolet range or into the infrared and microwave range. Photonic crystals with PBGs in the telecommunication wavelength range, for example, are conventionally manufactured using techniques borrowed from the silicon microelectronics industry, specifically lithography and etching, electrochemistry, and vertical selective oxidation. In U.S. Pat. No. 6,260,388, Borrelli et al., describe an alternative method of making photonic crystals by extruding glass powder with a binder through a mechanical die combined with a fiber drawing technique. In contrast, according to an embodiment of the present invention, individual fibers with specific core and clad properties are extruded, aligned, stacked, and then drawn under controlled conditions to produce photonic crystals.

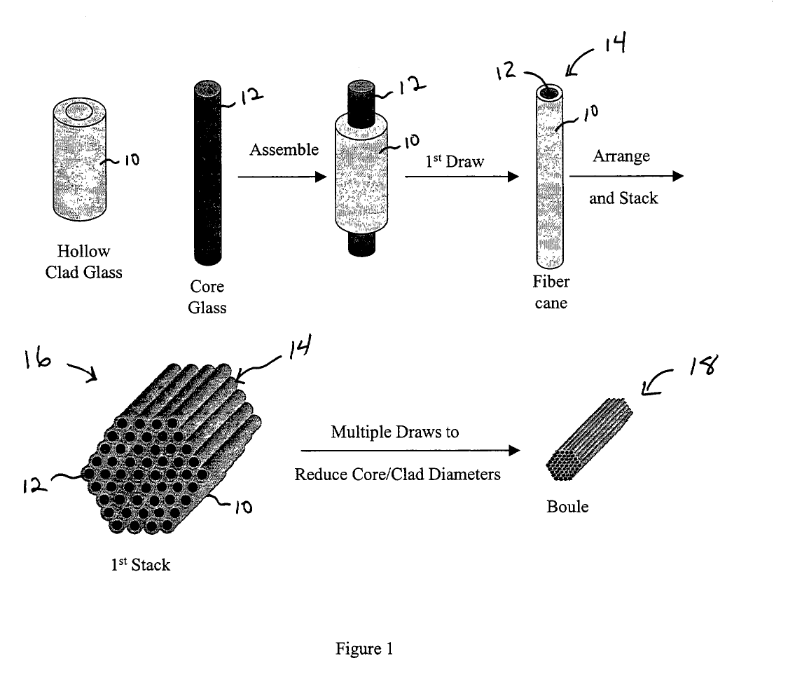

With reference now to FIG. 1, there is shown schematically how MCP photonic crystals are prepared. Initially, hollow billets of cladding glass 10 and solid rods of an etchable core glass 12 are assembled by inserting the etchable core glass 12 into the hollow billet of cladding glass 10. The cladding glass 10 with the inserted core glass 12 is pulled through a vertical oven, drawing the cladding glass 10 and core glass 12 to form a fiber cane 14. The type of cladding glass is not particularly limited and may include, but is not limited to silica and silica doped materials. Dopants such as germanium, phosphorus, boron, erbium, and flourine can be incorporated into the silica to increase or decrease the index of refractions as governed by the desired photonic band gap properties.

The fiber canes 14 may be cleaved at fixed lengths and are then stacked into an array 16. The number of fiber canes 14 that are stacked into an array is not particularly limited and will vary widely depending on the final application of the photonic crystal. Typically, hundreds to thousands of individual fiber canes 14 are stacked into an array 16. Preferably, the fiber canes are stacked such that they form a hexagonal array. Other geometric configurations are possible depending on the application. The hexagonal array is preferable because it allows for the closest packing of the fiber canes when multiple arrays are stacked together.

The array 16 may then be drawn one or more times to reduce the diameter of the core glass 12 and the diameter of the cladding glass 10. It will be appreciated by those skilled in the art that as the stack is successively drawn, the diameters of the core glass 12 and the diameter of the cladding glass 10 will get smaller. Further, the temperature of the oven required to draw the cladding glass 10 and the etchable core glass 12 will vary depending on the types of cladding glass and core glass used. The temperature should be set at a point where both the cladding glass and the core glass soften such that they are both drawable. Once the individual core glasses and cladding glasses have been reduced to the desired dimensions, the array may be fused together to form a boule 18. One skilled in the art will appreciate that one or more arrays may be stacked and fused together. The number of fiber canes that are stacked to form a boule 18 will depend on the application and desired size of photonic crystal. In some applications, the boule 18 may be drawn to further reduce the diameter of the core glass 12.

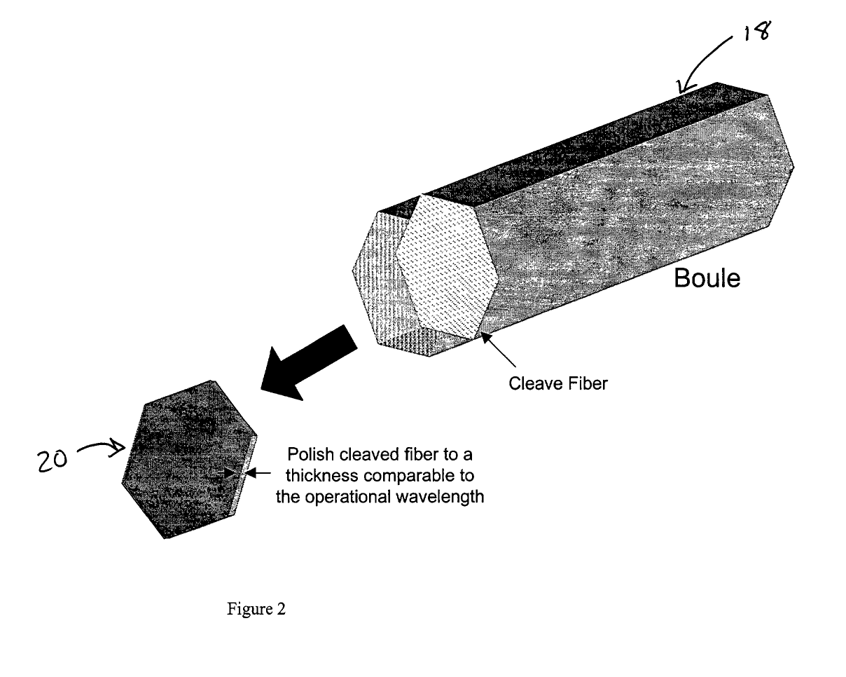

The boules 18 are cleaved to form a microchannel plate 20, as shown in FIG. 2. The microchannel plate 20 is preferably polished to a thickness comparable to the operational wavelength of the desired electromagnetic radiation to be controlled by filtering or by waveguiding depending on the application. This thickness is preferably on the order of the lattice spacing of the photonic crystal. In some embodiments, the thickness may range from about 400 nm to about 1.5 μm for optical applications; from about 1 mm to about 3 cm for microwave applications; and from about 3 cm to about 1.5 m for radio frequency applications. One skilled in the art will appreciate that multiple boules may be stacked and fused to form larger microchannel plates before cleaving.

The cleaved microchannel plates are then formed into photonic crystal structures by chemically removing the etchable cores, thus creating voids of air or “holes” within a matrix consisting entirely of cladding glass. This provides a matrix to air index of refraction ratio of anywhere from approximately 2.0 to 1.0 for alumina-doped cladding glasses to as low as 1.5 to 1 for more common germanium or phosphorous-doped cladding glasses. The value of this refractive index ratio governs the spectral bandwidth and structure of the photonic bandgap (PBG).

In a preferred embodiment, the photonic crystal preferably has a lattice spacing, ranging from one-fifth to a full operation wavelength to be controlled. As used herein, “lattice spacing” refers to the distance between the centers of each of the holes. In a preferred embodiment, the holes have diameter ranging from one-third to a full lattice spacing of the photonic crystal.

As will be discussed in detail below, the evacuated cores can be filled with an amorphous solid (gel) or liquid that has a higher refractive index than the clad matrix, to effectively create high index rods geometrically arranged in a low index matrix. Electrically conductive materials can also be incorporated into the vacant holes in these etched MCP templates.

One embodiment of the present invention is directed to introducing defects into the otherwise defect-free photonic crystal that disrupts the periodicity of the crystal defining micro-cavities, and in some embodiments, forms waveguides within the photonic crystal where incident electromagnetic energy can become localized and allowed to propagate. In preferred embodiments, the electromagnetic radiation is applied in a direction that is approximately orthogonal to the holes or micro-channels formed in the photonic crystal. The electromagnetic radiation will preferably be applied along the thickness of the cleaved plate and resulting photonic crystal, and not parallel with the holes or micro-channels. For optical photonic crystal waveguides, the transmission of electromagnetic energy is highly efficient, with analytical models illustrating efficiencies over 90%. Photonic crystal waveguides can even confine light around large angular displacements. In contrast, propagation in conventional fiber-optic waveguides is dictated by rules of total internal reflection preventing propagation through tight bends since the transversing light signal escapes at the corners resulting in high levels of loss and decreased output efficiencies.

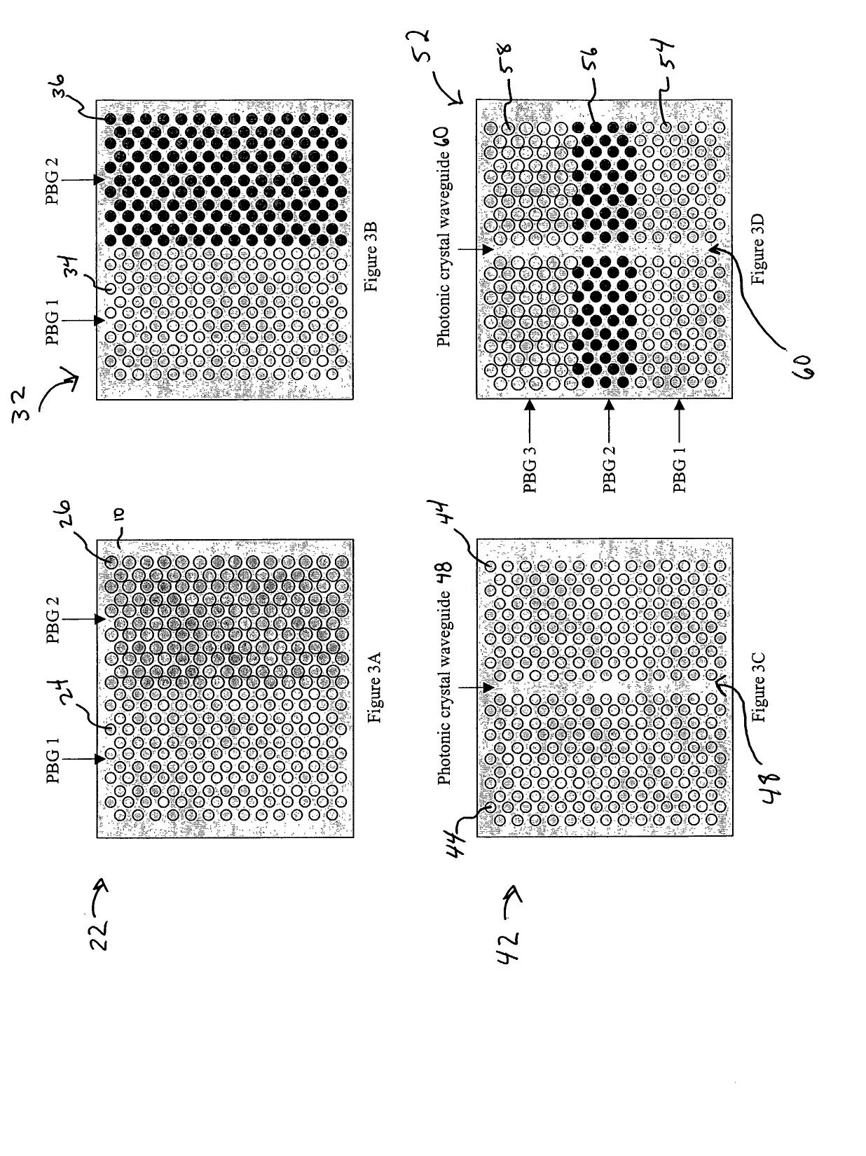

One method for introducing defects into the MCP photonic crystal is to utilize fiber canes 14 with different cladding glass and core glass diameters when assembling the stack 16. By utilizing fiber canes with differing diameters, the resulting MCP photonic crystal will have different regions in the photonic crystal that exhibit different crystal geometries (lattice spacing and diameters) and thus will have different propagation characteristics. FIG. 3A illustrates a MCP photonic crystal 22 where different sized canes were utilized in the formation process. Upon chemical etching, two different sized crystal regions may be formed comprised of periodic voids or holes 24 and 26. By having the two different sized holes 24 and 26 in different regions of the MCP photonic crystal 22, the resulting photonic crystal exhibits different PBG properties referred to as PBG 1 and PBG 2 in FIG. 3A. This type of MCP photonic crystal 22 maybe utilized as a broadband filter such that if electromagnetic radiation (“EMR”) outside the PBG passes through the PBG1 region 24 to reach the PBG1 region to 24 PBG2 region 26 interface, then PBG2 will filter out other EMR in accordance with the properties of PBG2.

In accordance with another embodiment, the material properties of the individual core and cladding glasses can be selected to engineer regions in the MCP photonic crystals with different refractive index ratios and/or different etching properties. With reference now to FIG. 3B, there is shown a MCP photonic crystal 32 that has two different photonic band gap regions PBG1 and PBG2. The region PBG1 32 illustrates an array of holes 34 in the photonic crystal. The region PBG2 illustrates a second array of holes 36 that are similar in size to the array of holes of PBG1 34, except that the second set of holes 36 have a different refractive index than the first array of holes 34. The second array of holes 36 can have a different refractive index by utilizing a core glass that has different etching properties than the core glass used to form the first array of holes 34. Alternatively, the second array of holes 36 may be filled with a material that has a different refractive index than the first array of holes 34. As in the case of defects with modified diameters, varying refractive index ratios create regions in the MCP photonic crystal where multiple PBGs can be located within one crystal structure. Thus, incident electromagnetic waves may interact with two or multiple PBGs where certain electromagnetic wavelengths are filtered when passed through the photonic crystal 32.

Introducing “defects” into the otherwise perfect crystal structure disrupts the periodicity of the crystal defining micro-cavities, and in some cases waveguides, where incident EMR can become localized and allowed to propagate. Waveguides may be formed by manipulating the etch properties of the core material With reference now to FIG. 3C, a MCP photonic crystal waveguide 42 is illustrated, where a row of defects form a waveguide 48 which extends between an array of periodic holes 44 from one end of the photonic crystal to the other. To form the waveguide 48, a non-etchable core is selected to match the refractive index of the clad glass. After being drawn and etched, the non-etchable cores remain creating a path for incident light to propagate, i.e. a waveguide 48. As an alternative, the cladding glass can be made solid, without the hollow center, and drawn. This remedies the situation of locating a non-etchable core with similar electromagnetic characteristics as in the cladding glass. In a preferred embodiment, the waveguide is preferably wide enough to allow the desired region of electromagnetic radiation to propagate through the waveguide. In one embodiment, the width of the waveguide corresponds to the removal of a single hole in the photonic crystal. In another embodiment, thinner or wider waveguides are used for controlling the propagating modes of EMR within the waveguide.

Additionally, any of the disclosed defect configurations could be combined together to assemble a single multifunctional photonic crystal. FIG. 3D illustrates a MCP photonic crystal waveguide that propagates through a series of regions with different PBG properties. The first region consists of a photonic band gap, PBG1, formed by an array of holes 54. A second photonic band gap region, PBG2, is formed where the array of holes 56 have a different refractive index from the first array of holes 54. A third photonic band gap region, PBG3 is formed from another array of holes 58 where the size of the holes is different from the holes for arrays 56 and 54. This forms a photonic crystal waveguide 60 that passes through all three photonic band gap regions, PBG1, PBG2, and PBG3. This would allow the formation of MCP photonic crystal waveguides that can propagate through multiple PBGs, all in a single platform. This type of configuration for a photonic crystal has direct relevance in wavelength division multiplexing applications.

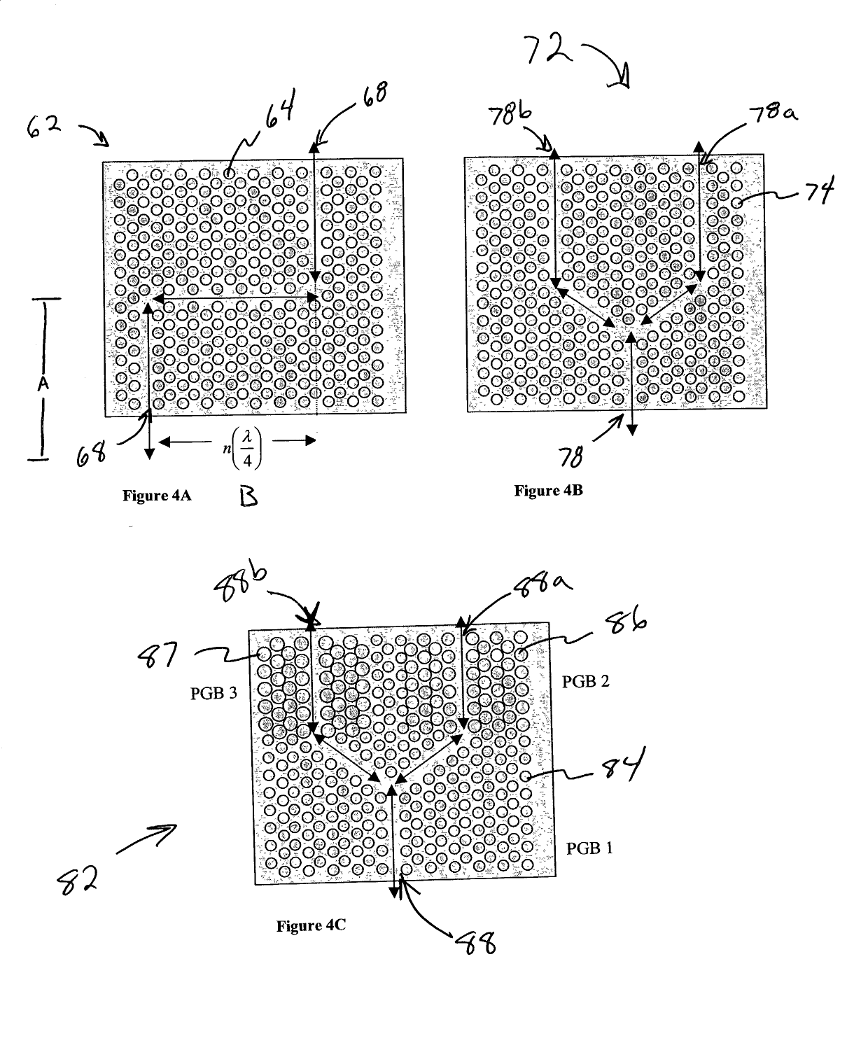

While the waveguide 48 and 60 illustrated in FIGS. 3C and 3D respectively are shown as extending linearly across the photonic crystal, the waveguides are not limited to this configuration. With reference now to FIG. 4A, a MCP photonic crystal device 62 is illustrated where a waveguide 68 extends through the photonic crystal 64 a distance A and then turns about 90 degrees and extends a distance B, followed by another bend of about 90 degrees such that the waveguide path extends away from distance A. If the distance B is a fraction of the wavelength of the desired electromagnetic radiation to be propagated, then the waveguide 68 acts as a phase delay or a phase shifting element. FIG. 4A illustrates one embodiment of a waveguide which is longitudinally offset by about an integer of one-fourth the wavelength of electromagnetic radiation to be propagated through the waveguide.

With reference now to FIG. 4B, another application of a waveguide is illustrated. Here, a waveguide 78 is divided into two separated waveguides, 78a and 78b through the array of holes 74 of the MCP photonic crystal 72. This type of configuration divides or combines the power through the two waveguide arms or paths 78a and 78b, depending on the direction of the electromagnetic radiation.

The above described concepts may be combined in a variety of combinations, depending on the desired properties of the photonic crystal. Turning now to FIG. 4C, a photonic crystal device 82 is illustrated where a waveguide 88 is divided into two separate paths 88a and 88b where all three paths of the waveguide are in three different PBG regions. In this embodiment, waveguide 88 extends through a photonic band gap region, PBG1, comprising of an array of holes 84. The waveguide path 88a extends through a photonic band gap region, PBG2, comprising a second array of holes 86. The waveguide path 88b extends through another photonic band gap region, PBG3, comprising a third array of holes 87, where the PBG1, PBG2, and PBG 3 are different. This type of MCP photonic crystal may be used as a multiplexer or a demultiplexer of electromagnetic radiation depending on the direction of the electromagnetic radiation source.

So far, we have described passive MCP photonic crystals where the photonic band gap is related to the size, shape, and content of the array of holes in the resulting photonic crystal. Any of the above described MCP photonic crystals may be made active in the sense that their associated photonic band gaps are tunable by filling the holes of the clad matrix with active materials that react to an applied field. The basic operation of the active devices described is that the applied external field leads to a change in the index of refraction of the material in the holes or an adjustment to the size or geometry of the hole, and thus a change in the analytical relation that defines and controls PBG. The applied fields may be electric, thermal, magnetic, optical or other such energy fields. Electro-optic, thermo-optic, magneto-optic, piezo-electric and other field-reactive materials deposited using electrostatic self-assembly (ESA) and other deposition techniques are capable of producing this effect.

Preferably, the field may be applied parallel to the hole or micro-channels in the photonic crystal or, in other embodiments, perpendicularly to the thickness of the photonic crystal. Additionally, anisotropic materials active materials can be used where the direction of the applied energy field can vary away from the perpendicular to the photonic crystal thickness.

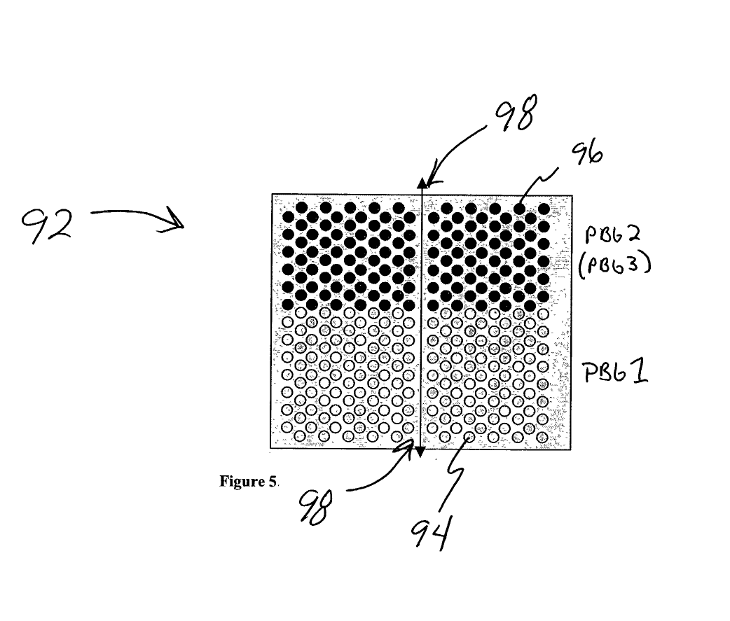

FIG. 5 illustrates one embodiment of an active MCP photonic crystal 92. The MCP photonic crystal structure 92 has a waveguide 98 that passes through a first photonic band gap region, PBG1, formed from an array of holes 94. The waveguide also passes through a second region of holes 96 that are filled with active material that changes its electromagnetic material properties based on an applied field. Possible materials include, but are not limited to, lithium niobate, barium titanate, lithium tantalate, potassium di-hydrogen phosphate, ammonium di-hydrogen phosphate, lead zirconia titanate, polyvinylidene fluoride, vinylidene fluoride, trifluoroethylene, liquid crystals, fluids and gels of various refractive indices, and other piezo-electric and thermo-optic polymers and electro-optic chromophores. Accordingly, the second region will have a photonic band gap corresponding to PBG2 in the absence of the field and PBG3 when the field is applied to the photonic crystal.

Using various combinations of the disclosed embodiment of the present invention, a range of optoelectronic components can be fabricated for operation in the optical telecommunication operation bands.

It will therefore be readily understood by those persons skilled in the art that the present invention is susceptible to broad utility and application. Many embodiments and adaptations of the present invention other than those herein described, as well as many variations, modifications and equivalent arrangement, will be apparent from or reasonably suggested by the present invention and the foregoing description thereof, without departing from the substance or scope of the present invention.

Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims and the equivalents thereof.

What is claimed is:

1. A method for making a photonic crystal having at least two photonic band gap regions comprising the steps of:
stacking a plurality of fiber canes together to form an array, wherein the plurality of fiber canes comprises a first set of fiber canes having a first set of core glass and a second set of fiber canes having a second set of core glass, wherein said first set of core glass has a different diameter than said second set of core glass;
reducing the diameter of said first set of core glass and said second set of core glass;
cleaving a portion of the array to form a plate; and
selectively removing at least a portion of said first set of core glass and said second set of core glass from said plate to form a photonic crystal.

2. The method of claim 1 wherein the step of reducing the diameter of said first set of core glass and said second set of core glass comprises the step of drawing the array two or more times.

3. The method of claim 1 wherein the step of stacking a plurality of fiber canes further comprises stacking a third set of fiber canes having a third set of core glass that is not removed which defines a waveguide in the photonic crystal.

4. A method for making a photonic crystal having a waveguide comprising the steps of:
stacking a plurality of fiber canes together to form an array, wherein the plurality of fiber canes comprises a first set of fiber canes having a first set of core glass and a second set of fiber canes having a second set of core glass;
reducing the diameter of said first set of core glass and said second set of core glass;
cleaving a portion of the array to form a plate; and
selectively removing at least a portion of said first set of core glass from said plate to form a photonic crystal having a waveguide defined by the location of the second set of fiber canes in the array.

5. The method of claim 4 wherein the step of reducing the diameter of said first set of core glass and said second set of core glass comprises the step of drawing the array two or more times.

6. The method of claim 4 wherein the step of stacking a plurality of fiber canes further comprises stacking a third set of fiber canes having a third set of core glass that is not removed which defines a waveguide in the photonic crystal.

7. The method of claim 4 wherein said second set of fiber canes is stacked to provide a linear waveguide in the photonic crystal.

8. The method of claim 4 wherein said second set of fiber canes is stacked to define a waveguide longitudinally offset by a fraction of the wavelength of the electromagnetic radiation to be propagated through the waveguide.

9. The method of claim 4 wherein said second set of fiber canes is stacked to define a waveguide having two or more paths extending through the photonic crystal.

10. A method for making a photonic crystal have at least two photonic band gap regions comprising the steps of:
stacking a plurality of fiber canes together to form an array, wherein the plurality of fiber canes comprises a first set of fiber canes having a first set of core glass and a second set of fiber canes having a second set of core glass, wherein said first set of core glass has different chemical etching properties than said second set of core glass;
reducing the diameter of said first set of core glass and said second set of core glass;
cleaving a portion of the array to form a plate; and
etching at least a portion of said first set of core glass to form a photonic crystal.

11. The method of claim 10 wherein the step of reducing the diameter of said first set of core glass and said second set of core glass comprises the step of drawing the array two or more times.

12. The method of claim 10 wherein the step of stacking a plurality of fiber canes further comprises stacking a third set of fiber canes having a third set of core glass that is not removed which defines a waveguide in the photonic crystal.

13. A method for making a photonic crystal having at least two photonic band gap regions comprising the steps of:
stacking a plurality of fiber canes together to form an array, wherein the plurality of fiber canes comprise a hollow clad glass with core glass having a diameter inserted therethrough;
reducing the diameter of said core glass;
cleaving a portion of the array to form a plate;
selectively removing at least a portion of said core glass such that the plate defines a plurality of holes corresponding to the removal of the core glass; and
filling at least a portion of said holes with a material having a different refractive index than the remaining holes.

14. The method of claim 13 wherein the step of reducing the diameter of said core glass comprises the step of drawing the array two or more times.

15. The method of claim 13 wherein said material exhibits a different refractive index when an energy field is applied.

16. The method of claim 15 wherein said energy field is selected from the group consisting of magnetic, thermal, optical, and electrical.

17. A method for making a photonic crystal having at least one photonic band gap region comprising the steps of:
stacking a plurality of fiber canes together to form an array, wherein the plurality of fiber canes comprises a set of fiber canes having a set of core glass;
reducing the diameter of said set of core glass;
cleaving a portion of the array to form a plate; and
removing at least a portion of said set of core glass to form a photonic crystal with at least one photonic band gap.
